(19) United States
(12) Patent Application Publication
(10) Pub. No.: US 2018/0157972 A1
(43) Pub. Date: Jun. 7, 2018

(54) PARTIALLY SHARED NEURAL NETWORKS FOR MULTIPLE TASKS

(71) Applicant: Apple Inc., Cupertino, CA (US)

(72) Inventors: Rui Hu, Santa Clara, CA (US); Kshitiz Garg, Santa Clara, CA (US); Hanlin Goh, Sunnyvale, CA (US); Ruslan Salakhutdinov, Pittsburgh, PA (US); Nitish Srivastava, San Francisco, CA (US); YiChuan Tang, Mississauga (CA)

(73) Assignee: Apple Inc., Cupertino, CA (US)

(21) Appl. No.: 15/828,399

(22) Filed: Nov. 30, 2017

Related U.S. Application Data
(60) Provisional application No. 62/429,596, filed on Dec. 2, 2016.

(51) Int. Cl. G06N 3/08; G06N 5/04; G06T 1/00; G06K 9/00

(52) U.S. Cl. CPC G06N 3/08; G06K 9/00791; G06T 1/0007; G06N 5/04

(57) ABSTRACT

A system includes a neural network organized into layers corresponding to stages of inferences. The neural network includes a common portion, a first portion, and a second portion. The first portion includes a first set of layers dedicated to performing a first inference task on an input data. The second portion includes a second set of layers dedicated to performing a second inference task on the same input data. The common portion includes a third set of layers, which may include an input layer to the neural network, that are used in the performance of both the first and second inference tasks. The system may receive an input data and perform both inference tasks on the input data in a single pass. During training, a training sample with annotations for both inference tasks may be used to train the neural network in a single pass.

### PRIORITY INFORMATION

This application claims benefit of priority to U.S. Provisional Application No. 62/429,596, filed Dec. 2, 2016, titled “Partially Shared Neural Networks for Multiple Tasks,” which is hereby incorporated by reference in its entirety.

### BACKGROUND

### Technical Field

This disclosure relates generally to systems and algorithms for machine learning and machine learning models. In particular, the disclosure describes a neural network configured to generate output for multiple inference tasks.

### Description of the Related Art

Neural networks are becoming increasingly more important as a mode of machine learning. In some situations, multiple inference tasks may need to be performed for a single input data sample, which conventionally results in the development of multiple neural networks. For example, in the application where an autonomous vehicle is using a variety of image analysis techniques to extract a variety of information from captured images of the road, multiple neural networks may be employed to analyze the image simultaneously. While such approaches are computationally feasible, they are nonetheless expensive and not easily scalable. Moreover, each separate neural network requires separate training, which further adds to the cost of such multitask systems.

### SUMMARY OF EMBODIMENTS

Described herein are methods, systems and/or techniques for building and using a multitask neural network that may be used to perform multiple inference tasks based on an input data. For example, for a neural network that perform image analysis, one inference task may be to recognize a feature in the image (e.g., a person), and a second inference task may be to convert the image into a pixel map which partitions the image into sections (e.g., ground and sky). The neurons or nodes in the multitask neural network may be organized into layers, which correspond to different stages of the inferences process. The neural network may include a common portion of a set of common layers, whose generated output, or intermediate results, are used by all of the inference tasks. The neuron network may also include other portions that are dedicated to only one task, or only to a subset of the tasks that the neural network is configured to perform. When an input data is received, the neural network may pass the input data through its layers, generating outputs for each of the multiple inference tasks in a single pass.

In some applications, the ability to efficiently make multiple inferences from a single sample of input data is extremely important. As one example, a neural network may be used by an autonomous vehicle to analyze images of the road, generating multiple outputs that are used by the vehicle's navigation system to drive the vehicle. The output of the neural network may indicate for example a drivable region in the image; other objects on the road such as other cars or pedestrians; and traffic objects such as traffic lights, signs, and lane markings. Such output may need to be generated in real time and at a high frequency, as images of the road are being generated continuously from the vehicle's onboard camera. Using multiple independent neural networks in such a setting is not efficient or scalable.

The multitask neural network described herein increases efficiency is such applications by combining certain stages of the different types of inference tasks that are performed on an input data. In particular, where the input data for the multiple inference tasks is the same, a set of initial stages in the tasks may be largely the same. This intuition stems from the way that the animal visual cortex is believed to work. In the animal visual cortex, a large set of low level features are first recognized, which may include areas of high contrast, edges, and corners, etc. These low-level features are then combined in the higher-level layers of the visual cortex to infer larger features such as objects. Importantly, each recognition of a type of object relies on the same set of low level features produced by the lower levels of the visual cortex. Thus, the lower levels of the visual cortex are shared for all sorts of complex visual perception tasks. This sharing allows the animal visual system to work extremely efficiently.

This same concept may be carried over to the machine learning world to combine neural networks that are designed to perform different inference tasks on the same input. By combining and sharing certain layers in these neural networks, the multiple inference tasks may be performed together in a single pass, making the entire process more efficient and faster. This is especially advantageous in some neural networks such as convolution image analysis networks, in which a substantial percentage of the computation for an analysis is spent in the early stages.

In addition, the multitask neural networks described herein may be more efficiently trained by using training data samples that are annotated with ground truth labels to train multiple types of inference tasks. The training sample may be fed into a multitask neural network to generate multiple outputs in a single forward pass. The training process may then compute respective loss function results for each of the respective inference tasks, and then back propagate gradient values through the network. Where a portion of the network is used in multiple tasks, it will receive feedback from the multiple tasks during the backpropagation. Finally, by training the multitask neural network simultaneously on multiple tasks, the training process promotes a regularization effect, which prevents the network from over adapting to any particular task. Such regularization tends to produce neural networks that are better adjusted to data from the real world and possible future inference tasks that may be added to the network. These and other benefits of the inventive concepts herein will be discussed in more detail below, in connection with the figures.

### BRIEF DESCRIPTION OF THE DRAWINGS

FIG. 1 is a diagram illustrating portions of a multitask neural network, according to some embodiments.

FIG. 2 is a diagram illustrating portions of the multitask neural network to perform image analysis tasks, according to some embodiments.

FIG. 3 is a flow diagram illustrating process of that may be performed by the a multitask neural network, according to some embodiments.

FIG. 4 illustrates an example autonomous vehicle using a multitask neural network to analyze road images, according to some embodiments.

FIG. 5 is a flow diagram illustrating a process of training the a multitask neural network, according to some embodiments.

FIG. 6 is a flow diagram illustrating another process of training the a multitask neural network, according to some embodiments.

FIG. 7 is a block diagram illustrating an example computer system that may be used to implement the methods and/or techniques described herein.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

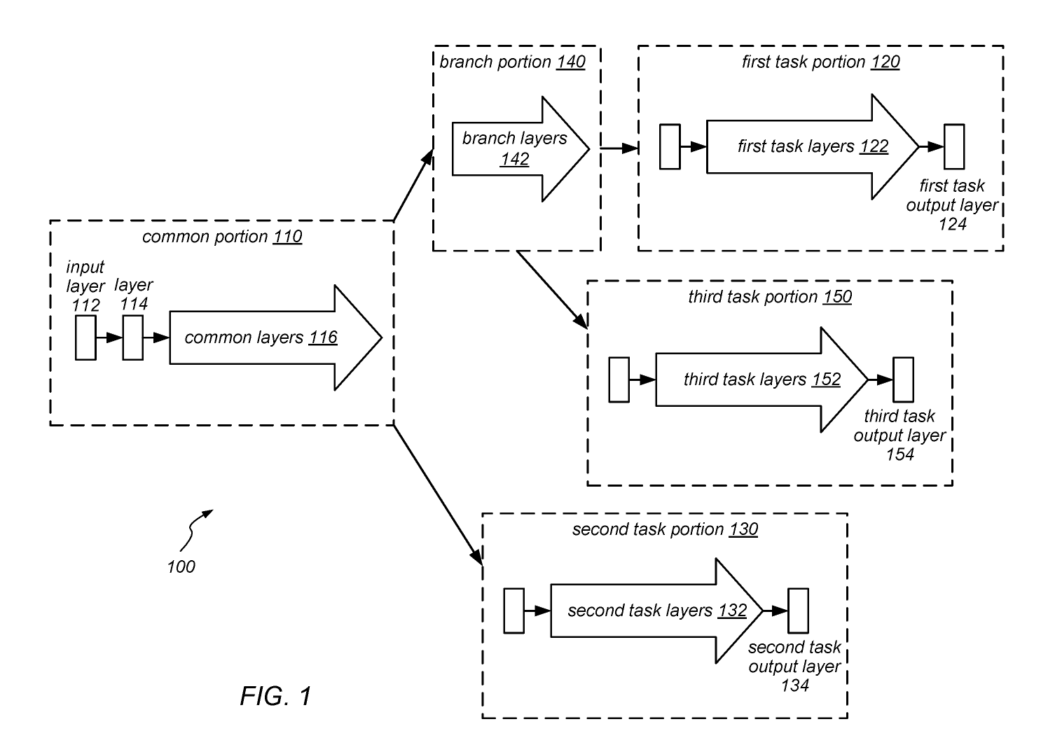

FIG. 1 is a diagram illustrating the portions of the multitask neural network, according to some embodiments. FIG. 1 depicts the architecture of a multitask neural network 100, which includes five portions: a common portion 110, a first task portion 120, a second task portion 130, a branch portion 140, and a third task portion 150.

Each portion 110, 120, 130, 140, and 150 comprises a number of layers. Each layer may include a number of neurons on nodes. In general, a neural network is a connected graph of neurons. Each neuron may a number of inputs and an output. The neuron may encapsulate a activation function that combines its inputs to produce its output, which may in turn be received as inputs to other neurons in the network. The connection between two neurons may be associated with vectors of parameters, such as weights, that can enhance or inhibit a signal that is transmitted on the connection. The parameters of the neural network may be modified through training, by repeatedly exposing the neural network to training data with known output results. During the training process, the neural network repeatedly generate output based on the training data, compare its output with the known results, and then adjust its parameters such that over time, it is able to generate approximately correct results for the training data. The neural network is thus a self-learning system that is trained rather than explicitly programmed. After a neural network is trained, its network parameters may be fixed. Given an input data, the neural network may produce an output that reflects properties about the input that the network was trained to extract. For example, as shown in FIG. 1, the input data is received via an input layer of neurons 112. In the multitask neural network 100, three outputs may be generated from the input data, at first task layer 124, second task layer, 134, and third task layer 154.

In some neural networks, a group of neurons may from a layer. A layer of neurons may collectively reflect a stage of an inference process that is implemented by the neural network. In some networks, sets of neurons in a layer may share the same activation function. For example, in an image analysis neural network, the nodes may be organized into layers that correspond to sets of feature maps, which may identify particular features and their corresponding locations in the input image. Each neuron in a feature map may represent the presence of a feature at an assigned location in the input image, and each neuron in the feature map may share the same activation function. In other types of neural networks, other types of stages may be implemented.

As illustrated, the neural network 100 is divided into five portions. Each portion may comprise a collection of connected layers. Each layer may receive inputs from one or more previous layers in the inference process, and generate output that are received by one more later layers. For example, as shown in common portion 110, the input layer 112 provides its output to an intermediate or hidden layer 114. In some neural networks, the layers may be organized into a directed acyclic graph.

In the illustrated neural network 100, the common portion 110 does not have any output layers. Rather, its common layers 116 generate intermediate results used by other portions of the network to generate output for inference tasks. As discussed, the multitask neural network may be able to perform multiple inference tasks on a sample of input data. The intermediate results generated by the output portion 110 may be generate any of its common layers 116.

As illustrated, the first task portion 120 may also include a plurality of layers, such as the first task layers 122, ending in a first task output layer 124. The first task output layer 124 may represent the final output for a first inference task. Such outputs may take a variety of forms. For example, in an image analysis neural network, the output may be a set of neurons representing a final feature map corresponding to the pixels of the input image. As another example, the output may simply provide a classification identifier, indicating the presence or type of subject matter detected in the input image. In some embodiments, the first task portion 120 may be the last set of layers that are performed prior to the first take output layer 124. The first task may comprise layers that are dedicated to the first inference task. That is, the output of the first task layers 122, including any intermediary output is only used to perform the first inference task. The output of the first task layers 122 are not used to perform any other inference tasks, such as the second or third inference tasks of the neural network 100.

Similar to the first task portion 120, the second task portion 130 may be a set of layers that are dedicated to a second inference task, which ends at the second task output layer 134. As with the first task layers 122, the output generated by the second task layers 132 may only be used for preforming the second inference task, and not any other task. This feature of the first task portion 120 and second task portion 130 differentiates these portions of the network 100 from the common portion 110, which produces outputs that are used to perform multiple inference tasks. In general, earlier layers in the network 100 may be more widely used. Indeed, in the illustrated network 100, there is only one input layer 112, and thus input layer 112 is used by all inference tasks supported by the neural network 100.

The neural network 100 may also have one or more branch portions, such as branch portion 140. Like the other portions in the network 100, the branch portion 140 also includes a set of layers, such as branch layers 142. Unlike the portions that are dedicated to a single inference task, such as first task portion 120, second portion task 130, and third task portion 150, the branch layers 142 may produce output that are used by layers of different inference tasks. However, unlike the common portion 110, the output of branch layers 142 may not be used for all inference tasks supported by the network 100. For example, as illustrated, the branch layers 142 of the branch portion 140 generates results used to by the first task portion 120 to perform the first inference task and also the third task portion 150 to perform the third inference task. However, the results generated by the branch layers 142 are not used by the second task portion 130 to perform the second inference task. Thus, the branch portion 140 represent a portion of the network 100 that includes a class of intermediate layers.

In this manner, the multitask neural network 100 may be configured to accept an input data at the input layer 112, and produce outputs for three separate inference tasks at first task output layer 124, second task output layer 134, and third task output layer 154, in a single pass. Where possible, common processing of two or more inference tasks may be carried out by shared portions of the network such as the common portion 110 or the branch portion 140. Thus, the architecture shown in FIG. 1 implements a multitask neural network that combines three inference tasks into one network, thereby enhancing the speed and efficiency of performing these tasks.

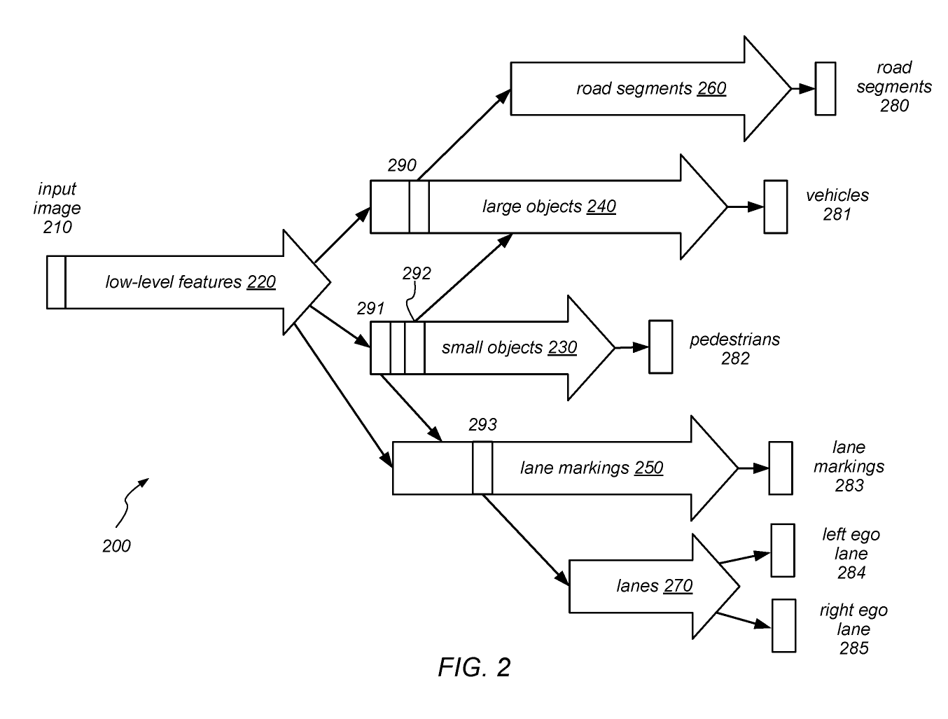

FIG. 2 is a diagram illustrating portions of the multitask neural network to perform image analysis tasks, according to some embodiments. In particular, neural network 200 illustrate an embodiment of a multitask network that may be used to make a number of inferences from an image about a road scene. Such a multitask neural network may be useful in an autonomous vehicle to infer one or more indication of road features.

As illustrated, the neural network 200 has an input image layer 210, which may be configured to receive an input image of a road scene. The multitask neural network 200 may be configured infer features from the input image and output results 280-285 on the right of the figure in a single pass. The input image layer 210 may extract a set of the lowest level features from the input image. For example, in some embodiments, the input image layer 210 may simply extract the RGB values of each pixel in the input image.

The input image layer 210 may be the first layer in the set of layers for low-level features 220. It should be noted that although the layers 220 and other layer sequences in FIG. 2 are represented as strict sequences, i.e., each layer has only one predecessor layer and one successor layer, this restriction is not necessarily true in practice and does not limit the inventive concepts described herein. In some embodiments, the layers in the neural network such as low-level feature layers 220 may have multiple predecessor layers and successor layers, which may be organized as a directed acyclic graph.

The layers for low-level features 220 may be a set of convolution layers that successively extract larger sets of higher level features from the input image, which may be represented as increasingly larger sets of feature maps of decreasing resolution. Due to the proliferation of features in convolution networks, the earlier layers of such networks are very compute intensive. The low-level features layers 220 may extract a set of low level features that may be shared by the later layers. Such features may indicate for example the presence of edges, corners, etc. in the input image. As illustrated, all of the layers 220 are common to all of the inference tasks for the neural network 200. Thus, the layers 220 represents the highest level common portion of the neural network 200.

In a convolution process, localized features of an image are extracted and then combined to recognize larger features in the image. The network may include a plurality of layers of neurons. Each neuron in a convolution layer may receive inputs from a set of neurons located in a small neighborhood in the previous layer. Thus, the input of each neuron is limited to a local receptive field of neighboring units from the previous layer. With local receptive fields, neurons can extract elementary visual features such as oriented edges, endpoints, corners from the input image. These features are then combined by the subsequent layers in order to detect higher order features.

The learned knowledge of one neuron in a layer can be replicated across a set of all neurons for the entire image by forcing the set to have the same parameters, such as weight or bias vectors. The set of neurons sharing parameters in such a fashion may be referred to as a feature map. The neurons in a feature map are all constrained to perform the same operation on different parts of the input image. Each layer in a convolution network may have a number of feature maps.

Once a feature has been detected in an image, its exact location may become less important. For example, once it is determined that the input image contains a series of lane markers at particular locations in the image, the exact location of each marker becomes less important. Thus, a next layer in a convolution may reduce the spatial resolution of the feature map using a down sampling or pooling operation, which is performed using a pooling layer. Neurons in the pooling layer may perform a local averaging and a subsampling to reducing the resolution of the feature maps. In some embodiments, a max-pooling function may be used, in which the maximum of a set input neurons in a pooling neighborhood in the previous feature map is used to compute the output. As a result, the resulting feature map may have less resolution than the previous feature map.

Successive convolution layers may be repeated. At each layer, the number of feature maps or extracted features is increased, and the dimensionality of the feature maps is decreased. In this manner, neural network 200 able to extract complex features that are useful to particular inference tasks.

The convolution techniques may be applicable to many applications outside of image recognition. For example, convolution neural networks may be used to recognize speech from audio data, by repeatedly generating features maps of local features in a sound sample, such as syllables, and then gradually inferring high-level features, such as words or sentences.

Turing back to FIG. 2, as illustrated, the low-level features layers 220 generate output that are used by four other groups of layers: the small objects layers 230, the large objects layers 240, and the lane markings layers 250. These layers 230, 240, and 250 may continue the convolution process in the low-level feature layers 220 to infer more and more higher order features. In some cases, a devolution process may be used near the end of an inference process of inference task. In a devolution process, a particular feature map is used to recreate the resolution of the input image. This may be used for example to perform an image segmentation task where the output of the inference process is an image of the same resolution as the input image indicating the drivable regions in the input image.

Pooling in a convolution network is designed to filter noisy features detections in earlier layers by abstracting the features in a receptive field with a single representative value. However, spatial information within a receptive field is lost during pooling, which may be critical for precise localization that is required for semantic segmentation. To resolve this issue, in some embodiments, unpooling layers may be employed in deconvolution process, which perform the reverse operation of pooling and reconstruct the original resolution of lower level feature maps, and ultimately the input image.

A deconvolution may be implemented by a set of deconvolution layers attached to the corresponding convolutions layers. During deconvolution, low resolution feature maps are successively unpooled and then deconvolved to generate a reconstruction of the layer that produced the feature map in question during the convolution process.

In some embodiments, the deconvolution process may employ an unpooling operation that reverses a max pooling used during convolution. In some embodiments, the max pooling operation is noninvertible. However, an approximate inverse may be obtained by recording the locations of the maxima within each pooling region in a set of switch variables. During deconvolution, the unpooling operation uses these recorded switches to place the reconstructions into appropriate locations, producing a set of unpooled maps.

A deconvolution operation may then be performed to convert the unpooled maps to reconstructed maps. The convolution process uses filters to convolve the feature maps from the previous layer. To approximately invert this process, the deconvolution operation may use transposed versions of the same filters to construct a sparsely populated feature map, padding some units with zeros. The deconvolution process may be applied repeatedly, increasing the dimensionality of the feature maps at each layer, until the dimensionality of the original input image is reached.

As can be seen in FIG. 2, at the certain points in particular inference tasks, one layer may generate an output that is used by another layer for perform another inference task. For example, one layer in the large objects layers 240, layer 290, generates an output that is used not only for the vehicles output layer 281, but also for the road segments output layer 280. Thus, layer 291 represents a branching point in the network 200, and the larger objects layers 240 before and including the layer 290 represents a branch portion, as discussed in connection with FIG. 1. On the other hand, since none of the layers in the larger objects layer 240 are used for multiple inference tasks (they are only used to generate the output for the vehicles output layer 281), those layers represent a dedicated task portion of the network 200, which is dedicated to the vehicles task. Similarly, layers 291, 292, and 293 also represent branching points in the network 200. During training, these branching points may receive feedback from the results of multiple inference tasks, and must account for these multiple feedbacks during the learning process.

The inference task output layers 280-285 may generate the final output for the set of inference tasks supported by the network 200. As illustrated, inference tasks of the network 200 are associated with extracting feature of a road scene. Such inference tasks may be useful for an autonomous vehicle, which relies on these types of indications to control the movement of the vehicle. A variety of road features that may be extracted from an input image. Such features include for example, observed vehicles, pedestrians, road segments, lanes, and lane markings. One road feature that may be important to an autonomous vehicle is the lane that the vehicle is currently occupying, or the “ego” lane. As illustrated, two extracted features from the road image are the left ego lane 284 and the right ego lane 285, which may represent the left and right boundaries of the vehicle's current lane, as seen in the input image.

The outputs from layers 280-285 may take different forms. In some cases, the output may be a classification type. In other cases, the output may comprise a confidence map. In yet other cases, the output may comprise a polygon on the image indicating the location of a detected feature. In some embodiments, the output may correspond to classification task, in which the neural network identifies a type of an object seen in the image. Alternatively, the output may correspond to a segmentation task, in which the image is divided into specific areas. For example, one segmentation task that is useful to autonomous vehicle is the segmentation of a road image into drivable and non-drivable regions. In some embodiments, the output may be associated with an inference task that is a combination classification and segmentation task. For example, an inference task may use the network 200 to identify a pedestrian and then generate a confidence map of the image indicating the location of the pedestrian in the image.

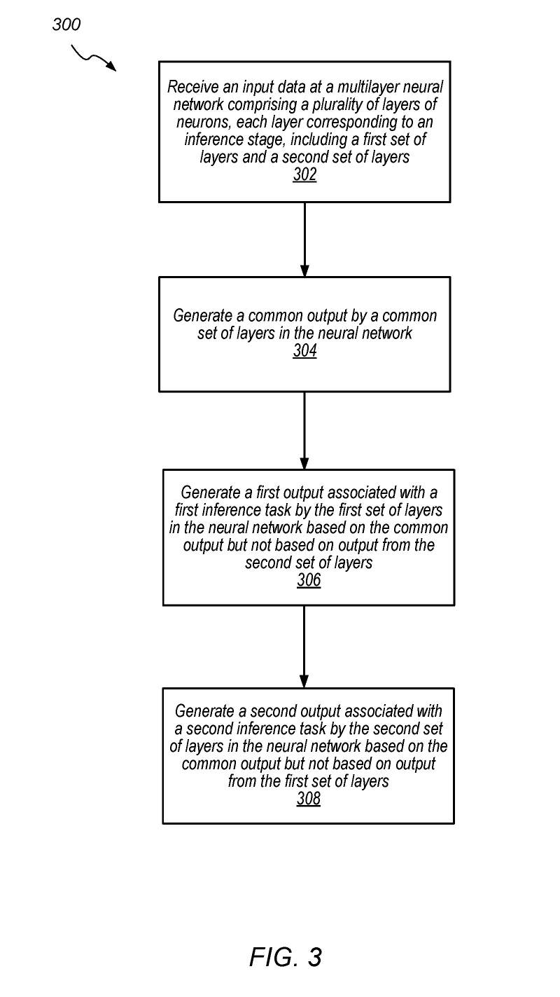

FIG. 3 is a flow diagram illustrating process of that may be performed by the a multitask neural network, according to some embodiments. Process 300 may be a computer implemented method that is carried out one or more computing devices including one or more processors and associated memory.

At operation 302, an input data is received by a multilayer neural network comprising a plurality of layers of neurons, each layer corresponding to an inference stage of the neural network. The multilayer neural network may be the neural network 100 discussed in connection with FIG. 1. The input data may be received by an input layer of the neural network. The neural network may include a common set of layers, a first set of layers, and a second set of layers.

At operation 304, a common output is generated by the common set of layers in the neural network. The common set of layers may be the common layers 116 in the common portion 110 of neural network 100 on FIG. 1. The common output may be output values generated by the neurons of the common layers 116 and received as input by nodes in subsequent layers of the neural network.

At operation 306, a first output associated with a first inference task is generated by the first set of layers in the neural network based at least in part on the common output, but not based on output from the second set of layers. The first set of layers may be for example the first task layers 122 in the first task portion 120, as discussed in connection with FIG. 1. The first set of layers may include a first task output layer 124 for the first inference task. The first set of layers may be dedicated to the first inference task, and output of the neurons in the first set of layers are not used to perform any other tasks supported by the neural network.

At operation 308, a second output associated with a second inference task is generated by the second set of layers in the neural network based at least in part on the common output, but not based on output from the first set of layers. The second set of layers may be for example the second task layers 132 in the second task portion 130, as discussed in connection with FIG. 1. The second set of layers may include a second task output layer 124 for the second inference task. The second set of layers may be dedicated to the second inference task, and output of the neurons in the second set of layers are not used to perform any other tasks supported by the neural network.

The operations of process 300 may be performed in a single pass of the multilayer neural network. Thus, the process 300 describes performing two inference tasks on the same input data. In the early stages of the inference, the processing may be the same for the first and second inference tasks. For those stages, the processing is performed using the set of common layers, thereby saving time and compute power. For the later stages that are specific to the two inference tasks, the processing is performed separately by the two sets of dedicated layers.

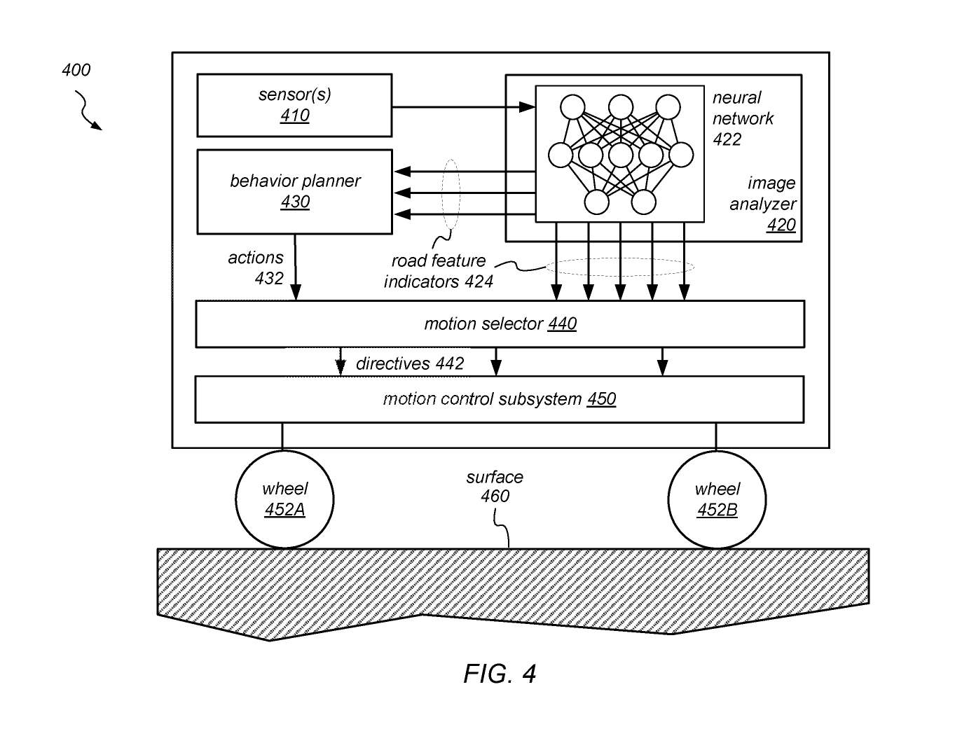

FIG. 4 illustrates an example autonomous vehicle using a multitask neural network to analyze road images, according to some embodiments. Vehicle 400 depicts an autonomous or partially-autonomous vehicle. The term “autonomous vehicle” may be used broadly herein to refer to vehicles for which at least some motion-related decisions (e.g., whether to accelerate, slow down, change lanes, etc.) may be made, at least at some points in time, without direct input from the vehicle's occupants. In various embodiments, it may be possible for an occupant to override the decisions made by the vehicle's decision making components, or even disable the vehicle's decision making components at least temporarily. Furthermore, in at least one embodiment, a decision-making component of the vehicle 400 may request or require an occupant to participate in making some decisions under certain conditions. The vehicle 400 may include one or more sensors 410, an image analyzer 420, a behavior planner 430, a motion selector 440, and a motion control subsystem 450. The vehicle 400 may comprise a plurality of wheels including wheels 452A and 452B, which are controlled by the motion control subsystem 450 and contacts a road surface 460.

The motion control subsystem 450, may include components such as the braking system, acceleration system, turn controllers and the like. The components may collectively be responsible for causing various types of movement changes (or maintaining the current trajectory) of vehicle 400, e.g., in response to directives or commands issued by decision making components 430 and/or 440. In a tiered approach towards decision making, the motion selector 440 may be responsible for issuing relatively fine-grained motion control directives 442 to various motion control subsystems. The rate at which directives 442 are issued to the motion control subsystem 450 may vary in different embodiments. For example, in some implementations the motion selector 450 may issue one or more directives 442 approximately every 40 milliseconds, which corresponds to an operating frequency of about 25 Hertz for the motion selector 450. Under some driving conditions (e.g., when a cruise control feature of the vehicle is in use on a straight highway with minimal traffic) directives 442 to change the trajectory may not have to be provided to the motion control subsystems at some points in time. For example, if a decision to maintain the current velocity of the vehicle is reached by the decision-making components, and no new directives 442 are needed to maintain the current velocity, the motion selector 440 may not issue new directives even though it may be capable of providing such directives at that rate.

The motion selector 440 may determine the content of the directives 442 to be provided to the motion control subsystem 450 based on several inputs in the depicted embodiment, including conditional action and state sequences 432 generated by the behavior planner 430, as well as the image analyzer 420. The image analyzer 420 may be implement by an onboard computer of the vehicle 400. The image analyzer 420 may implement a neural network 422, which may be a multitask neural network discussed in connection with FIG. 3. The neural network 422 may receive images comprising road scenes from the sensors 410 at a regular frequency. Each image may be analyzed by the neural network 422 to extract a plurality of road features, such as the features generated from output layers 280-285 in FIG. 3. The road features may be extracted in a single pass of the neural network 422, and outputted by the image analyzer 420 in a plurality of road feature indicators 424. The road feature indicators 424 may be provided to both the behavior planner 430 and the motion selector 440, which uses the road feature indicators 424 issue action sequences 432 in the case of behavior planner 430 or control directives 442 in the case of motion selector 440.

Inputs may be collected at various sampling frequencies from individual sensors 410 by the image analyzer 420. In some embodiments, the output may comprise a video camera that generates images at a certain frame rate. The image analyzer 420 may pass every receive frame of the video camera to the neural network 422. Alternatively, the image analyzer 420 may analyze the video frames at a slowly frequency than the rate that the frames are being generated. In one embodiment, the output from a sensor 410 may be sampled at approximately 10× the rate at the motion selector than the rate at which the output is sampled by the behavior planner. Different sensors may be able to update their output at different maximum rates in some embodiments, and as a result the rate at which the output is obtained at the behavior planner and/or the motion selector may also vary from one sensor to another. A wide variety of sensors 410 may be employed in the depicted embodiment, including cameras, radar devices, LIDAR (light detection and ranging) devices and the like. In addition to conventional video and/or still cameras, in some embodiment near-infrared cameras and/or depth cameras may be used.

Using the components shown in FIG. 4, the autonomous vehicle 400 may be able to continuously track the salient features of the road via the sensors 410. The multitask neural network 422 is able to extract multiple road features from the road images quickly and efficiently in a single pass, thus allowing road feature data to be presented at a sufficiently high frequency to be used by vehicle control systems such as the behavior planner 430 and the motion selector 440 to control the movements of the vehicle 400.

As with any neural network, the multitask neural network may be trained using training data. The training process may back propagate the gradient of the error of network regarding the network's modifiable weights. Where a portion of the network is used in multiple tasks, it will receive feedback from the multiple tasks during the backpropagation. By training the multitask neural network simultaneously on multiple tasks, the training process promotes a regularization effect, which prevents the network from over adapting to any particular task. Such regularization tends to produce neural networks that are better adjusted to data from the real world and possible future inference tasks that may be added to the network.

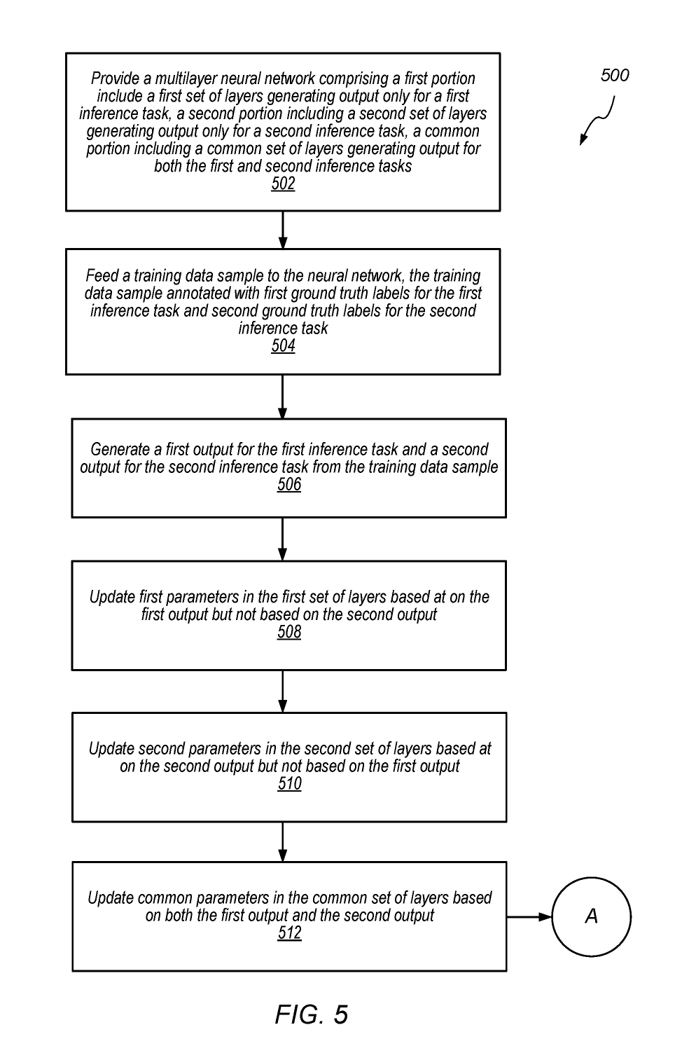

FIG. 5 is a flow diagram illustrating a process of training the a multitask neural network, according to some embodiments. Process 500 begins at operation 502, where a multilayer neural network is provided. The multilayer neural network comprises a plurality of neurons organized in layers, a first portion including a first set of layers generating output only for a first inference task, a second portion including a second set of layers generating output only for a second inference task, a common portion including a common set of layers generating output for both the first and second inference tasks. The multilayer neural network may be the neural network 100 of FIG. 1.

At operation 504, a training data sample is fed to the multitask neural network. The training data sample is annotated with first ground truth labels for the first inference task and second ground truth labels for the second inference task. Thus, the training data sample may be used to train the network for both inference tasks simultaneously.

At operation 506, the multitask neural network generates a first output for the first inference task and a second output for the second inference task from the training data sample. This operation represents the forward pass of the training process.

At operation 508, a set of first parameters in the first set of layers is updated based at least in part on the first output, but not based on the second output. Operation 508 represents part of the backward pass of the training process. During this stage, the ground truths associated with the first inference task is used to compute an error of the first output. The process proceeds backwards trough the network to compute the errors of all at the intermediate neurons for the first output. Gradients are then computed using the error and the input to the neuron. The gradient is used to adjust the parameters (e.g., the weight) at that particular neuron. For a neuron that is only used for the first inference task, there is no error or gradient associated with the second inference task. Thus, at operation 508, the second output does not impact the update to the first parameters of the first set of layers.

At operation 510, a set of second parameters in the second set of layers is updated based at least in part on the second output, but based not on the first output. As explained in connection with operation 508, because the second set of layers is not associated with the first inference task, there is no error or gradient computed for the neurons in these layers. Thus, at operation 510, the first output does not impact the update of the second parameters of the second set of layers.

At operation 512, a set of common parameters of the common set of layers is updated based at least in part on both the first output and the second output. The output of neurons in the common set of layers are used for both the first and the second inference tasks. Thus, an error and gradient can be computed for a neuron in the common set of layers from both inference tasks. In updating the parameters of a neuron in the common set of layers, the neuron may take into account both errors and/or gradients by combining the two values. In some embodiments, the combination may involve averaging the two gradients. In some embodiments, the averaging may comprise a weighted averaging, where for example the first gradient is granted more importance in the update by applying that gradient with a larger weight coefficient than the second gradient. In this way, the errors from the first inference task may have a bigger impact on the training of the network than errors from the second inference task. The combination approach may be generalized to more than two inference tasks, such that a neuron that contributes to the output for N inference tasks may combine N gradients to slowly learn to minimize error for all N inference tasks.

In some cases, the weight coefficients associated with the training of neurons may be configurable by the neural network's trainer. Thus, a trainer may assign different weight coefficients to each of the different inference tasks that the neural network supports. The weight coefficients may be normalized by constraining their sum to be for example 1. The weight coefficients may be adjusted during the training to encourage the neural network to learn one task faster versus another task. The trainer may also instruct the neural network to ignore a particular task by setting the weight coefficient for the gradients to 0. A setting of 0 for an inference task may operate to gate off any learning from the outputs of that task. In practice, for a training data set that has no truth labels for a particular inference task, the weight coefficient for that task may be set to 0 to ensure that nothing in the output of that task inadvertently impacts the training of the network.

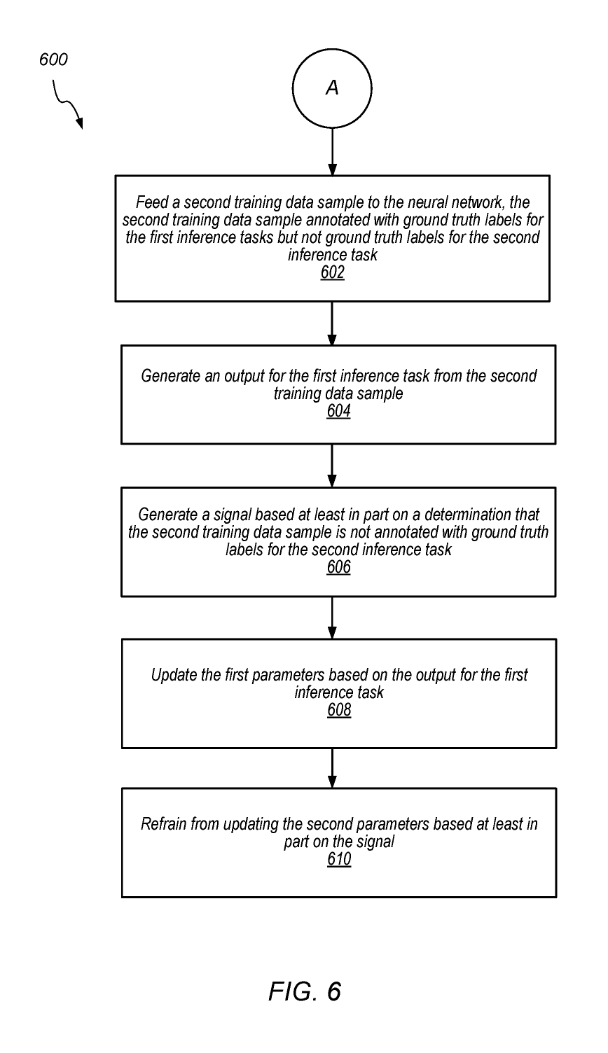

FIG. 6 is a flow diagram illustrating another process of training the a multitask neural network, according to some embodiments. Process 600 depicts a situation where the training data sample lacks the ground truth labels for a particular inference task supported by the multitask neural network. The operations of process 600 may be an addition to or separate from the operations of process 500. However, as depicted, process 600 depends from process 500, in particular operation 502 of the process 500.

At operation 602, a second training data sample is fed to the neural network of the process 500. The second training data sample is annotated ground truth labels for the first inference tasks but not ground truth labels for the second inference task. At operation 604, the neural network generates an output for the first inference task from the second training data sample, similar to operation 506 in process 500 for the first training data sample.

At operation 606, a signal is generated based at least in part on a determination that the second training data sample is not annotated with ground truth labels for the second inference task. Operation 606 may be performed by the training software used to train the multitask neural network. Operation 606 may prior to the backpropagation stage, when the training software determines that there are no ground truth labels for the second inference task and thus cannot compute the errors or gradient values for the second inference task. The generated signal may be a control signal to that gates off part of the backpropagation for updates based on the output for the second inference task. For example, the signal may cause training software to set the weight coefficient for the second inference task to 0, ensuring that no feedback is propagated for that task.

At operation 608, the first parameters in the first set of layers are updated based at least in part on the output for the first inference task. Since ground truth labels for the first inference task exists, the backpropagation process may occur as normal for the first inference task. Operation 608 may occur in similar fashion as operation 508 in process 500.

At operation 610, the training software and/or neural network may refrain from updating the second parameters of the second set of layers based at least in part on the signal that was generated in operation 606. The act of refraining may occur via logic in a software routine, or via the configuration of a parameter in the update calculation for the parameters. For example, one way to not update the second parameters is to configure weight coefficient for the second inference task to 0, thereby gating off any impacts from the output for the second inference task.

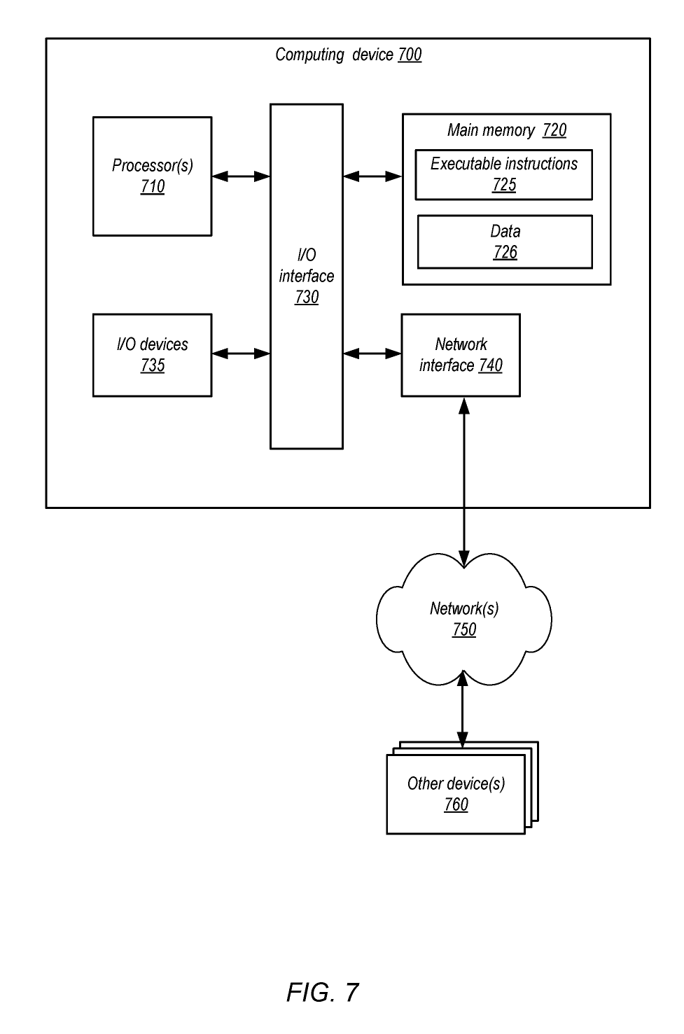

In at least some embodiments, a system and/or server that implements a portion or all of one or more of the methods and/or techniques described herein, including the techniques to refine synthetic images, to train and execute machine learning algorithms including neural network algorithms, and the like, may include a general-purpose computer system that includes or is configured to access one or more computer-accessible media. FIG. 7 illustrates such a general-purpose computing device 700. In the illustrated embodiment, computing device 700 includes one or more processors 710 coupled to a main memory 720 (which may comprise both non-volatile and volatile memory modules, and may also be referred to as system memory) via an input/output (I/O) interface 730. Computing device 700 further includes a network interface 740 coupled to I/O interface 730, as well as additional I/O devices 735 which may include sensors of various types.

In various embodiments, computing device 700 may be a uniprocessor system including one processor 710, or a multiprocessor system including several processors 710 (e.g., two, four, eight, or another suitable number). Processors 710 may be any suitable processors capable of executing instructions. For example, in various embodiments, processors 710 may be general-purpose or embedded processors implementing any of a variety of instruction set architectures (ISAs), such as the x86, PowerPC, SPARC, or MIPS ISAs, or any other suitable ISA. In multiprocessor systems, each of processors 710 may commonly, but not necessarily, implement the same ISA. In some implementations, graphics processing units (GPUs) may be used instead of, or in addition to, conventional processors.

Memory 720 may be configured to store instructions and data accessible by processor(s) 710. In at least some embodiments, the memory 720 may comprise both volatile and non-volatile portions; in other embodiments, only volatile memory may be used. In various embodiments, the volatile portion of system memory 720 may be implemented using any suitable memory technology, such as static random access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, executable program instructions 725 and data 1926 implementing one or more desired functions, such as those methods, techniques, and data described above, are shown stored within main memory 720.

In one embodiment, I/O interface 730 may be configured to coordinate I/O traffic between processor 710, main memory 720, and various peripheral devices, including network interface 740 or other peripheral interfaces such as various types of persistent and/or volatile storage devices, sensor devices, etc. In some embodiments, I/O interface 730 may perform any necessary protocol, timing or other data transformations to convert data signals from one component (e.g., main memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components. Also, in some embodiments some or all of the functionality of I/O interface 730, such as an interface to memory 720, may be incorporated directly into processor 710.

Network interface 740 may be configured to allow data to be exchanged between computing device 700 and other devices 760 attached to a network or networks 750, such as other computer systems or devices as illustrated in FIG. 1 through FIG. 6, for example. In various embodiments, network interface 740 may support communication via any suitable wired or wireless general data networks, such as types of Ethernet network, for example. Additionally, network interface 740 may support communication via telecommunications/telephony networks such as analog voice networks or digital fiber communications networks, via storage area networks such as Fibre Channel SANs, or via any other suitable type of network and/or protocol.

In some embodiments, main memory 720 may be one embodiment of a computer-accessible medium configured to store program instructions and data as described above for FIG. 1 through FIG. 10 for implementing embodiments of the corresponding methods and apparatus. However, in other embodiments, program instructions and/or data may be received, sent or stored upon different types of computer-accessible media. Various embodiments may further include receiving, sending or storing instructions and/or data implemented in accordance with the foregoing description upon a computer-accessible medium. Generally speaking, a computer-accessible medium may include non-transitory storage media or memory media such as magnetic or optical media, e.g., disk or DVD/CD coupled to computing device 700 via I/O interface 730. A non-transitory computer-accessible storage medium may also include any volatile or non-volatile media such as RAM (e.g. SDRAM, DDR SDRAM, RDRAM, SRAM, etc.), ROM, etc., that may be included in some embodiments of computing device 700 as main memory 720 or another type of memory. Further, a computer-accessible medium may include transmission media or signals such as electrical, electromagnetic, or digital signals, conveyed via a communication medium such as a network and/or a wireless link, such as may be implemented via network interface 740. Portions or all of multiple computing devices such as that illustrated in FIG. 13 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

The various methods and/or techniques as illustrated in the figures and described herein represent exemplary embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended to embrace all such modifications and changes and, accordingly, the above description to be regarded in an illustrative rather than a restrictive sense.

While various systems and methods have been described herein with reference to, and in the context of, specific embodiments, it will be understood that these embodiments are illustrative and that the scope of the disclosure is not limited to these specific embodiments. Many variations, modifications, additions, and improvements are possible. For example, the blocks and logic units identified in the description are for understanding the described embodiments and not meant to limit the disclosure. Functionality may be separated or combined in blocks differently in various realizations of the systems and methods described herein or described with different terminology.

These embodiments are meant to be illustrative and not limiting. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the disclosure as defined in the claims that follow.

Although the embodiments above have been described in detail, numerous variations and modifications will become apparent once the above disclosure is fully appreciated. It is intended that the following claims be interpreted to embrace all such variations and modifications.

What is claimed is:

1. A system comprising:
one or more computing devices each comprising one or more processors and memory, the computing devices implementing a neural network comprising:
a plurality of neurons configured to perform a plurality of inference tasks including a first inference task and a second inference task, the neurons organized in a plurality of layers corresponding to stages of inference made by the neural network;
a first portion of the neural network comprising a first set of the plurality of layers including a first output layer configured to produce output for the first inference task performed on an input data, wherein output produced by the first set of layers are only used to perform the first inference task;
a second portion of the neural network comprising a second set of the plurality of layers including a second output layer configured to produce output for the second inference task performed on the input data, wherein output produced by the second set of layers are only used to perform the second inference task; and
a common portion of the neural network comprising a common set of the plurality of layers including an input layer configured to receive the input data, wherein the common set of layers produces output that are used to perform the plurality of inference tasks, including the first and the second inference tasks.

2. The system of claim 1, further comprising:
a branch portion of the neural network distinct from the common portion, comprising a branch set of the plurality of layers, wherein the branch set of layers receives as input the output produced by the common portion and produces output that is used by the first portion to perform the first inference task and a third portion of the neural network to perform a third inference task, but not used by the second portion to perform the second inference task.

3. The system of claim 1, wherein:
the input layer is configured to receive an input image; and
the plurality of layers comprises one or more layers that correspond to respective sets of feature maps associated with features extracted from the image.

4. The system of claim 3, wherein:
the common set of layers of the common portion comprises at least one layer that is a convolution layer; and
the first set of layers of the first portion comprises at least one layer that is a deconvolution layer.

5. The system of claim 3, wherein the neural network is configured to perform a first inference task comprising an image classification task, and perform a second inference task comprising an image segmentation task.

6. The system of claim 3, further comprising:
a sensor of an autonomous vehicle configured to capture images of road scenes; and
a motion selector of the autonomous vehicle configured to receive outputs of the first and second inference tasks produced by the neural network and generate control directives to a motion control subsystem of the autonomous vehicle based at least in part on the outputs of the first and second inference tasks; and
wherein the neural network receives the images captured by the sensor and performs the first and second inference tasks on the received images.

7. The system of claim 6, wherein the neural network is configured to produce an output of the first or second inference task, the output indicating a feature of the received image selected from the group consisting of a vehicle, a pedestrian, a road segment, or a lane.

8. A computer implemented method comprising:
receiving an input data at an input layer of a multilayer neural network comprising a plurality of layers of neurons, each layer corresponding to an inference stage of the neural network;
generating a common output by a common set of layers in the neural network, the common set of layers including the input layer;
generating a first output associated with a first inference task by a first set of layers in the neural network based at least in part on the common output; and
generating a second output associated with a second inference task by a second set of layers in the neural network based at least in part on the common output;
wherein the first inference task is not performed using the second set of layers, and the second inference task is not performed using the first set of layers, and the first inference task and the second inference task are performed in single pass of the neural network.

9. The computer implemented method of claim 8, wherein:
receiving the input data comprises receiving an input image; and
generating the common output comprises generating one or more convolved feature maps associated with one or more respective features extracted from the input image; and
generating the first output comprises generating one or more deconvolved feature maps associated with respective ones of the one or more convolved feature maps.

10. The computer implemented method of claim 9, wherein:
generating the first output comprises performing an image classification task; and
generating the second output comprises performing an image segmentation task.

11. The computer implemented method of claim 9, wherein:
receiving the input image comprises capturing the input image using a sensor on an autonomous vehicle, the input image comprising an image of a road scene; and
generating the first output comprises generating an output indicating a first road feature in the input image;
generating the second output comprises generating an output indicating a second road feature in the input image; and further comprising:
generating, by a motion selector of the autonomous vehicle, one or more control directives to a motion control subsystem of the autonomous vehicle that controls movement of the autonomous vehicle.

12. The computer implemented method of claim 11, wherein generating the first output or generating the second output comprises generating an indication of a road feature in the input image selected from the group consisting of a vehicle, a pedestrian, a road segment, or a lane.

13. A method comprising:
providing a multilayer neural network comprising a plurality of neurons organized in layers, a first portion including a first set of layers generating output only for a first inference task, a second portion including a second set of layers generating output only for a second inference task, and a common portion including a common set of layers generating output for both the first and second inference tasks;
feeding a training data sample to the neural network, the training data sample annotated with first ground truth labels for the first inference task and second ground truth labels for the second inference task;
generating, by the neural network, first output for the first inference task and second output for the second inference task from the training data sample;
updating first parameters in the first set of layers based at least in part on the first output but not based on the second output;
updating second parameters in the second set of layers based at least in part on the second output but not based on the first output; and
updating common parameters of the common set of layers based at least in part on both the first output and the second output.

14. The method of claim 13, further comprising:
feeding a second training data sample to the neural network, the second training data sample annotated with ground truth labels for the first inference task but not ground truth labels for the second inference task;
generating, by the neural network, an output for the first inference task from the second training data sample;
generating a signal based at least in part on a determination that the second training data sample is not annotated with ground truth labels for the second inference task;
updating the first parameters based at least in part on the output for the first inference task; and
refraining from updating the second parameters based at least in part on the signal.

15. The method of claim 13, wherein updating the common parameters for the common set of layers comprises combining a first value and a second value, the first value being based at least in part on the first output and a first weight coefficient associated with the first inference task, and the second value being based at least in part on the second output and a second weight coefficient associated with the second inference task.
